(19) United States
(12) Patent Application Publication
(10) Pub. No.: US 2008/0016662 A1
(43) Pub. Date: Jan. 24, 2008

(54) Method And Arrangement For Manufacturing Grid For Lead Battery Plate

(76) Inventor: Gyorgy Andras Sarosi, Budapest (HU)

Correspondence Address: BIRCH STEWART KOLASCH & BIRCH, PO BOX 747, FALLS CHURCH, VA, 22040-0747, US

(21) Appl. No.: 11/571,153

(22) PCT Filed: Jun. 25, 2004
(86) PCT No.: PCT/HU04/00068

§ 371 Date: Jun. 14, 2007

(51) Int. Cl. H01M 4/84; H01M 4/73

(52) U.S. Cl. 29/2

(57) ABSTRACT

Method and arrangement for manufacturing grids for lead battery plates, forming a patterned grid of lead or lead alloy within a frame. A sheet of fibreglass based insert (7) is introduced between a pair of casting belts (1), which move along a travel path having a contacting section. Molten lead or lead alloy from a dispensing means (8) is applied on both sides of the sheet of fibreglass based insert (7) before reaching the contacting section, and leaving that a continuous plurality of separate grids (13) are formed on the continuous insert (7) at the output. A cooling effected by a cooler (10) is applied to at least a part of the contacting section during travelling of the casting belts (1).

The present invention relates to an improved method and to a corresponding arrangement for manufacturing a grid for lead battery plate. More particularly the invention is a method usable in manufacturing grids for lead battery plates, forming a patterned grid of lead or lead alloy within a frame, According to this method a sheet of fibreglass based insert is introduced between a pair of casting belts, which casting belts move along a travel path having a contacting section. Molten lead or lead alloy is applied on both sides of the sheet of fibreglass based insert before reaching the contacting section; and leaving the contacting section a continuous plurality of separate grids are formed on the continuous insert at the output.

Various technologies are known in manufacturing lead grids, such as gravity casting, stretch rolling, etc. There have been several proposals for reducing the thickness of the lead grid as well as for increasing the ability of retaining the active mass. Such proposal is described in U.S. Pat. No. 6,228,537 in which a stronger grid is provided by forming ribs. The disadvantages originating from alloying with antimony still exist: the thickness of the grid can be reduced only to a small extent (approximately 1.2 mm). U.S. Pat. No. 4,782,585 discloses a grid made of acid-resistant synthetic resin substrate coated with lead. Although mechanical resistance is improved, the insulating core decreases conductivity and the thickness of the plate can not be reduced.

The most relevant technical solution is described in WO 03/038933 of the same applicant, which is considered herewith attached as a reference. As it is clear from this, one of the best ways of producing a very thin grid plate is such a continuous manufacturing line where a fibreglass based insert material is coated with molten lead. One of the embodiments shown is a continuous casting with an endless belt of chain elements, as illustrated in FIG. 7 of the reference. This is possessing disadvantage, namely closing the quite big sized rigid chain elements, when filling with molten lead may be critical. One other embodiment of FIG. 9 of the reference uses a flexible endless belt supported with a rotating cylinder on the other side, where the fibreglass based insert is between them. A disadvantage of the illustrated arrangement is that at the quite small driving rollers due to which also at the casting section CD the wear of the belt is considerable. The final product at point D is solidified in a slightly curved form, which need an additional step to form a flat one. Synchronization of the cylinder and the belt is also a problem due to the different driving and guiding means. But, however, the main problem is the solidifying in the casting section CD. This requires very slow motion, and/or use of molten lead at just above the melting temperature. Using a cold cylinder would case a considerable transversal gradient in the temperature, thus double sided casting is not possible.

There is also a problem, however, that the lead or lead alloy material used for the subject process shows abrupt phase transition, without an intermediate semi-solid state. For the sake of manufacturing reliable product preferably a slightly higher temperature is to be used for the molten lead when applied on the sides of the sheet insert. Also a very long closed state time is required for the casting belts, which affect the productivity.

The object of the present invention is an improved method for continuous manufacturing grids for lead battery, where fibreglass based insert is introduced between two inversely rotated endless casting belts, which are made of a flexible sheet material, preferably steel, and provided with required patterns on their outer side. The molten lead is applied on both sides of the insert so that it fills in the given pattern while adhering to the insert.

A further object of the present invention is to make continuous manufacturing process more reliable, even by using higher temperature molten lead at the input points.

A further object of the present invention is to manufacture a continuous plurality of separate double sided grids on the continuous insert at the output.

On the other hand a further object of the present invention to speed up casting productivity at the same time.

The present invention is based on additional use of a cooling section further to a pair of driven casting belts. This is in response to the fact that the lead and lead alloys used preferably for manufacturing grids shows abrupt phase transition, without an intermediate semi-solid state. It had to recognize that the casting elements passing the cooling section should be of small thermal capacity, i.e. of quite small mass.

Along the contacting section, i.e. the closed state of the travel path a mechanical solidifying and a chemical bond between lead and fibreglass material are creating.

Accordingly in the method for manufacturing grids for lead battery plates a sheet of fibreglass based insert is introduced between a pair of casting belts, which move along a travel path having a contacting section. Molten lead or lead alloy is applied on both sides of the sheet of fibreglass based insert before reaching the contacting section. Leaving the contacting section a continuous plurality of separate grids are formed on the continuous insert at the output. A cooling is applied at least a part of the contacting section during travelling of the casting belts.

The cooling may be a contact cooling. A heating may also be applied to a second section being opposite to the contacting section along the travel path.

The corresponding arrangement comprising a molten lead dispensing means connected to a molten lead source, and driving means and guiding means for the casting belts, constituting the travel path having the contacting section. The molten lead dispensing means is placed before the contacting section. At least along a part of the contacting section the casting belts are guided through a cooler providing said cooling.

The travel path is mainly defined by heated rolls at its upper part, and lower guide elements, placed in downstream direction from the rolls, at its lower part. The lower guide elements may be fixed guide plates. The cooler may constitute a part of the guiding means, guiding tightly the inner sides of the two casting belts.

The invention will be further described in details with reference of the accompanying drawings.

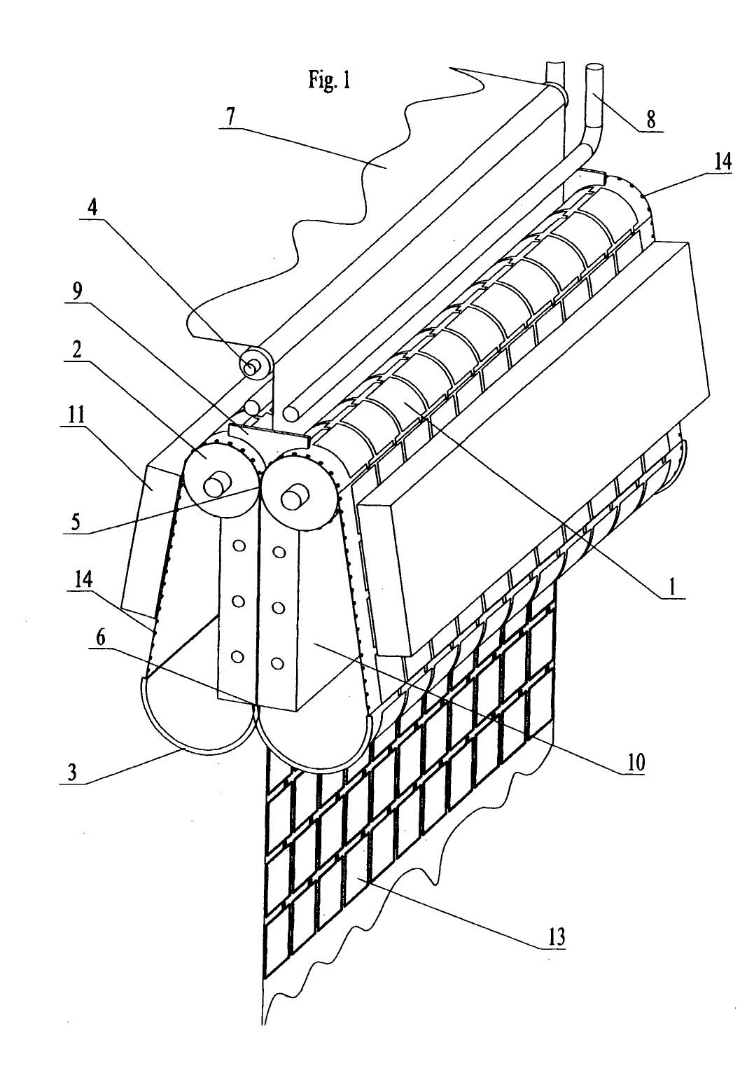

FIG. 1 is a perspective view of the arrangement according to the invention.

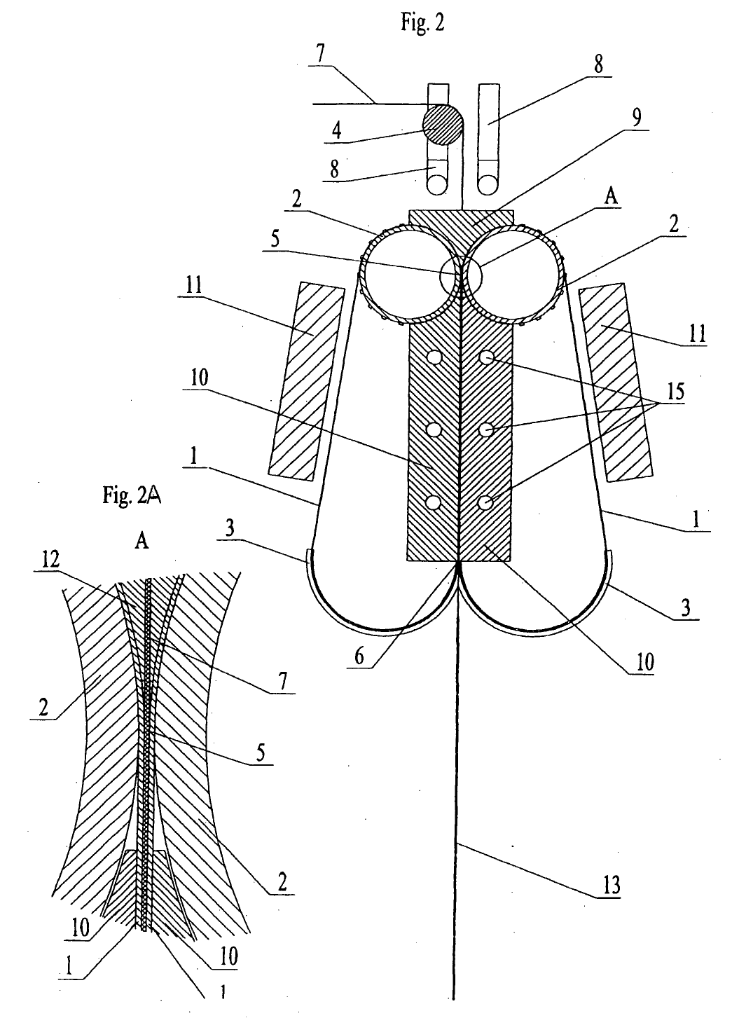

FIG. 2 is a side view of the arrangement of FIG. 1.

FIG. 2A is an enlarged part “A” of the FIG. 2 at the same view.

The casting belts 1 as it can be seen in FIG. 1 are typically made of steel. On one side of the belts are shallow cavities for the molten lead. The two belts 1 are of the same like, but different travel path or length can also be possible. In FIG. 2 the symmetric travel path of the casting belts 1 can be seen in the plane of the drawing which is transversal to the plane of the belts. The travel path is defined by rolls 2 at its upper part and lower guide elements 3, placed in downstream direction from the rolls 2, at the lower part of the travel path. The outer surface of rolls 2 are preferably heated. There is a contacting section between rolls 2 and lower guide elements 3, i.e. between the first and last contacting points 5 and 6 respectively. The length of the contacting section is in close correlation with the travelling speed and necessary solidifying time for the input molten lead in the casting cavities formed by halves of the contacting pair of belts 1. During travelling through this section the lead has to become solidified, constituting separate grids on the continuous insert material at the output. The splitting process of the output product, i.e. a continuous plurality of separate grids 13 formed on the continuous insert 7 at the output, can be made by known method, thus it is not described herewith.

The contacting section is to be understood with such a contacting manner that a thin sheet material insert 7 is introduced and pressed into the gap between the outer surfaces of the belts 1. The insert 7 is made of fibreglass based material, for example of woven fibreglass textile. The molten lead or lead alloy spread from lead outlet 8 is cover this fibreglass based material extremely good, and an additional chemical bond is also achieved in the sense of the following. In lead and in all of its alloy there is some oxygen present in the form of lead-oxide at molecular thickness of layer. With free silicate anions that can be found on the surface of the fibreglass, this layer forms lead-silicates. This process creates a strong mechanical bond between the fibreglass and the lead material of the grid as well as that of the later applied active mass. This bond will continuously grow stronger along time passing.

Since a thin lead-oxide pellicle can be found on the surface of the molten lead, with silicon-dioxide which makes a considerable part of the fibreglass, this will form pentaplumbo-trisilicatex (5PbO+3SiO₂=Pb₅Si₃O₁₁). This compound or bond can be produced immediately on the meeting surfaces of the two materials at even zero ° C. (up to 450° C.), and assures strong adhesion between lead and the fibreglass without the need of pressing as soon as the surfaces come into contact. In this way it is possible for the frame and the grid portion to be made of at least 99.99% pure lead which is still able to fill in the casting die cavity properly. Also, known alloying elements may be used such as Sn and/or Ag and/or Na.

The new material originating from the two materials of the meeting surfaces of the lead and the fibreglass is lead glass. This continues to be the component of the two original materials in the future and at the same time a common part of the newly formed lead glass.

The rolls 2 and the lower guide elements 3 are constructed that they have a radius of sufficiently large measure in order to preserve the belt from enhanced wear. This means that the travel path is about a shape of rounded trapezoid, having smoothly arched relatively large round. The relatively large is to be understood in regard of the leaning ability of the material, preferably steel material of the belt 1.

The lower guide elements 3 may be, according to the drawings, simply fixed guide plates, for example made of metal and covered with a lubricant layer. Alternatively an arched row of driving rolls on the inner side also can be used (not illustrated). In this disclosure the inner surface or inner side of the casting belt 1 is to be understood as that of facing to the respective closed inner space in FIG. 2 which is surrounded by the drawing line of the belt 1 which is identical to the travel path.

The molten lead or lead alloy is dispensed from the lead outlet 8 onto the outer surface of the casting belt 1 before the first contacting point 5 respective to the travelling direction of the casting belt 1. There is a hopper or a mouth 9 provided as a puffer for the molten lead upper part of the path, before the first contacting point 5. As it can be seen in FIG. 2B, which is an enlarged detail “A” of FIG. 2, the insert 7 is going through a triangular cross section of the mouth 9 filled with molten lead supply 12, level of which is kept by the dispensing lead outlet 8 from above. At the first contacting point 5 the molten lead is getting closed within the shallow cavities on the outer surfaces of both casting belts, but split by the central insert 7. At the beginning of the contacting section, i.e. at the first contacting point 5 the casting cavities defining the grid pattern are containing molten lead of the liquid phase. According to the invention a cooling is applied to the inner surface of the casting belts 1 along the contacting section, during travelling of the casting belts 1. This cooling is preferably effectuated by a cooler 10 on both sides, which may be a contact cooler. This kinds of coolers are known, they can be supplied by circulated cold cooling fluid for example. In FIG. 1 there are holes to symbolize ducts 15 in the body of the coolers 10. This cooling is used for the sake of reducing solidifying time, and thus increasing manufacturing productivity and also product quality. This latter is a consequence of using a molten lead of the sufficiently high temperature in the mouth 9, thus ensuring the reliable filling of casting cavities at around the first contacting point 5, and even obtaining reliably solidified grids on the insert 7 at the last contacting point 6. This is very important taking into consideration the already mentioned abrupt solidifying properties of the lead metal.

The cooling is applied to at least a part of the contacting section. Preferably, if other contravening respects do not occur, the cooling might be applied substantially to the whole length of the contacting section, as it is illustrated in the drawings, where the entering edge of the cooler 10 is just near to the first contacting point 5. However the space rendered for the cooler 10 may limit the partial length of the previously defined contacting section where the cooler 10 is placed.

The cooler 10 has a further function to guide tightly the inner side of the casting belts 1, and in such a way the casted insert 7 along the contacting section when the lead becomes solid. This guiding function can be achieved by several known technical manner, for example by lubricated support area. The cooler together with its guiding function is preferably extending to the whole width of the casting belts 1, similarly to that of rolls 2 and lower guide elements 3. However the stretch applied on casting belts 1 along their travel paths makes possible to keep them together also in those remaining length of the contacting section in which no direct guidance from the cooler 10 is present.

On the other hand there is a need to re-heath the cooled casting belt 1 before the first contacting point 5. Although rolls 2 are heated, preferably by built-in electric heater, the relatively short part of the travel path around the upper half of rolls 2 may insufficient to reach the desirable temperature for receiving the molten lead from mouth 9. Therefore a supplemental heating is applied to a second section being opposite to the contacting section along the travel path of the casting belt 1. The heathers 11 may be radiant or contact heathers of the known kinds.

Driving of the casting belts 1 can be supported separately from the guiding elements, from the rolls 2 for example. This is schematically illustrated in FIG. 1 by the perforation 14 at the edge of the endless belts 1. The perforation 14 can be in engagement of a separate driving mechanism (not illustrated), such as a motor with cog-wheel.

1. Method for manufacturing grids for lead battery plates, forming a patterned grid of lead or lead alloy within a frame, where a sheet of fibreglass based insert is introduced between a pair of casting belts, which casting belts move along a travel path having a contacting section; molten lead or lead alloy is applied on both sides of the sheet of fibreglass based insert before reaching the contacting section; and leaving the contacting section a continuous plurality of separate grids are formed on the continuous insert at the output,
characterized in that a cooling is applied to at least a part of the contacting section during traveling of the casting belts.

2. The method according to claim 1, characterized in that the cooling is a kind of contact cooling applied on the inner surface of the casting belt.

3. The method according to claim 1 or 2, characterized in that a heating is applied to a second section being opposite to the contacting section along the travel path of the casting belt.

4. Arrangement for manufacturing grids for lead battery plates, forming a patterned grid of lead or lead alloy within a frame, which arrangement comprising a pair of driven casting belts, a supply of sheet fibreglass based insert material, introduced between the casting belts, a molten lead source, a molten lead dispensing means connected to the molten lead source, driving means and guiding means for the casting belts, constituting a travel path having a contacting section, the molten lead dispensing means being placed before the contacting section,
characterized in that at least along a part of the contacting section the casting belts are guided through a cooler.

5. The arrangement according to claim 4, characterized in that the travel path is defined by heated rolls at its upper part, and lower guide elements, placed in downstream direction from the rolls, at its lower part.

6. The arrangement according to claim 4 or 5, characterized in that the lower guide elements are fixed guide plates.

7. The arrangement according to claim 4 or 5, characterized in that the cooler is constituting a part of the guiding means, guiding tightly the inner sides of the two casting belts.
